(19) United States
(12) Patent Application Publication
(10) Pub. No.: US 2018/0172060 A1
(43) Pub. Date: Jun. 21, 2018

(54) CASE-NUT

(71) Applicant: TOYOTA JIDOSHA KABUSHIKI KAISHA, Toyota-shi (JP)

(72) Inventor: Hitoshi NAKAO, Nissin-shi (JP)

(73) Assignee: TOYOTA JIDOSHA KABUSHIKI KAISHA, Toyota-shi (JP)

(21) Appl. No.: 15/835,512

(22) Filed: Dec. 8, 2017

(30) Foreign Application Priority Data
Dec. 16, 2016 (JP) 2016-244465

(51) Int. Cl. F16B 41/00; F16B 33/00

(52) U.S. Cl. CPC F16B 41/002; F16B 33/004

(57) ABSTRACT

A case-nut includes a case welded to a body of a vehicle, a bolt insertion hole being formed in the case, a nut accommodated in the case and disposed to be movable in the case, and an insulating film laminated on an end face of the nut on the case side and an end face of the nut on the body side.

### INCORPORATION BY REFERENCE

The disclosure of Japanese Patent Application No. 2016-244465 filed on Dec. 16, 2016 including the specification, drawings and abstract is incorporated herein by reference in its entirety.

### BACKGROUND

### 1. Technical Field

The disclosure relates to a case-nut.

### 2. Description of Related Art

A case-nut disclosed in Japanese Patent No. 6016981 includes a case welded to the body of a vehicle and a nut disposed in the case. The case is a metallic case and has an upper wall in which a bolt insertion hole is formed and a peripheral wall extending from the peripheral edge of the upper wall toward a lower part on the body side. The peripheral wall has a lower end portion that is bent radially outward and constitutes a flange, and the flange is welded to the body. The nut is placed on the body and is disposed apart from the case. The nut is disposed such that it can be moved in the case.

In other words, the nut can be moved with respect to a bolt inserted into the upper wall, and the axes of the nut and the bolt can be aligned with each other even when the insertion position of the bolt with respect to the bolt insertion hole changes. The nut is moved upward and abuts against the upper wall of the case by the bolt and the nut being fastened to each other with the axes of the nut and the bolt aligned with each other.

A metallic nut main body and a resinous insulating member insert-molded on the outer surface of the nut main body constitute the nut. The insulating member is disposed such that it covers the side surface of the nut main body and the lower surface of the nut main body on the body side. The nut is placed on the body as described above, and thus is apart from the case in a state where a bolt is yet to be assembled. In this state, the insulating member of the nut abuts against the body. Accordingly, the nut is insulated with respect to the body and the case. Electrodeposition coating is performed on the body in a state where the case-nut is assembled. Energization of the nut is more appropriately suppressed when the electrodeposition coating is performed on the body. As a result, a coating film is unlikely to be produced on the outer surface of the nut, and sticking of the nut to the case and the body is more appropriately suppressed.

### SUMMARY

Spot welding or the like is used when the case of the case-nut is welded to the body. The current that flows during the welding generates a magnetic field. The nut main body of the case-nut is metallic, and thus may be magnetized by the magnetic field generated during the welding. In this case, the upper surface of the nut may be attached to the upper wall of the case, even before the bolt fastening, due to the magnetic force of the nut main body. In the case-nut disclosed in Japanese Patent No. 6016981, the upper surface of the nut main body is not coated with the insulating member, and thus the upper surface of the nut main body and the upper wall of the case may come into contact with each other in a case where the nut main body is magnetized. In this case, the nut is energized via the case during the electrodeposition coating and a coating film is produced on the outer surface of the nut. Sticking may occur between the nut and the case as a result.

An aspect relates to a case-nut including a case welded to a body of a vehicle, a bolt insertion hole being formed in the case, a nut accommodated in the case and disposed to be movable in the case, and an insulating film includes at least a first insulating film laminated on an end face of the nut on the case side and a second insulating film laminated on an end face of the nut on the body side.

According to the aspect, the insulating film is disposed on the end face of the nut on the case side and the end face of the nut on the body side. The nut may be attached to the case in a case where the nut is magnetized by, for example, the magnetic field that is generated when the case is welded to the body. Insulation of the nut with respect to the case is ensured even in this state since the nut is connected to the case via the insulating film that is disposed on the end face on the case side. In a case where the nut is not magnetized, for example, the nut is separated from the case and the insulating film that is disposed on the end face on the body side abuts against the body. Accordingly, insulation of the nut with respect to the body is ensured as well. Therefore, according to the above-described configuration, energization of the nut via the case and the body is more appropriately suppressed when electrodeposition coating is performed on the body that is assembled with the case-nut. Therefore, no coating film is produced on the outer surface of the nut during electrodeposition coating, and sticking of the nut to the case and the body attributable to a coating film can be more appropriately suppressed.

In the case-nut according to the aspect, the insulating film may have a thickness of 5 micrometers to 40 micrometers. According to the aspect, the thickness of the insulating film is set to 5 micrometers to 40 micrometers. In a state where a bolt is fastened to the nut in the case-nut, the end face of the nut on the case side is pressed against the case. Accordingly, the insulating film is sandwiched by the nut and the case. According to the above-described configuration, the insulating film has a relatively small thickness, and thus the insulating film rarely affects the fastening and the same fastening force as in a case where the insulating film is not disposed can be guaranteed.

In the case-nut according to the aspect, the insulating film may cover an entire outer surface of the nut. According to the aspect, the entire outer surface of the nut is covered by the insulating film. Accordingly, the nut is reliably insulated with respect to the case and the body. Accordingly, sticking of the nut to the case and the body attributable to electrodeposition coating can be more appropriately suppressed.

The case-nut according to the aspect may further include a support bracket accommodated in the case and including a connecting portion joined to the case and a support portion supporting the nut.

In the case-nut according to the aspect, the support portion of the support bracket may have a through-hole into which the nut is inserted.

In the case-nut according to the aspect, the nut may include a flange portion disposed between an upper wall of the case and the support portion of the support bracket and a main body portion connected to the flange portion and extending into the through-hole in the support portion.

In the case-nut according to the aspect, the insulating film may be disposed on an upper surface of the flange portion, which is the end face of the nut on the case side.

In the case-nut according to the aspect, the second insulating film may be disposed on a lower surface of the flange portion, which is the end face of the nut on the body side, the insulating film may further include a third insulating film laminated on a side surface of the main body portion, and the second insulating film and the third insulating film may abut against the support bracket.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a top view illustrating a configuration of the body of a vehicle in which a case-nut is assembled;

FIG. 2 is a perspective view schematically illustrating a configuration of a connecting member connected to a support member;

FIG. 3 is a sectional view of the case-nut;

FIG. 4 is a perspective view of a support bracket;

FIG. 5 is a cross-sectional view taken along line V-V of FIG. 3;

FIG. 6 is a bottom view of a nut;

FIG. 7 is a half sectional view schematically illustrating a configuration of the nut and an insulating film;

FIG. 8 is a sectional view illustrating a configuration of the inner portion of the case-nut at a time when the nut is magnetized;

FIG. 9 is a sectional view illustrating how the nut rotates in a through-hole;

FIG. 10 is a sectional view illustrating a configuration of a modification example of the case-nut;

FIG. 11 is a sectional view illustrating a configuration of the inner portion of the case-nut according to the modification example at a time when the nut is magnetized;

FIG. 12 is a sectional view illustrating a configuration of a modification example of the case-nut; and

FIG. 13 is a sectional view illustrating a configuration of a modification example of the case-nut.

### DETAILED DESCRIPTION OF EMBODIMENTS

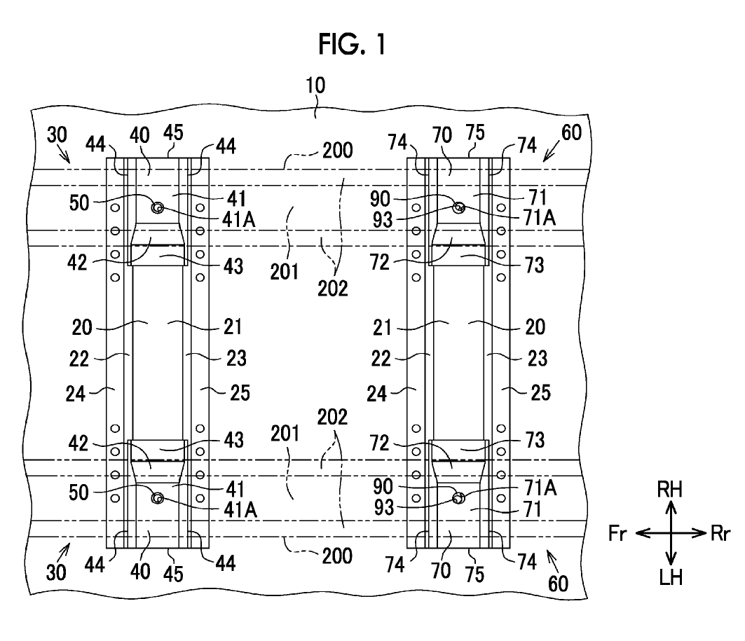

Hereinafter, an embodiment of a case-nut will be described with reference to FIGS. 1 to 9. In the present embodiment, a case-nut that is used when a slide rail of a vehicle seat is fastened to the body of a vehicle will be described as an example. The “Fr”, “Rr”, “RH”, “LH”, and “Upr” shown in the drawings represent the front of the vehicle, the rear of the vehicle, the right-hand side in the width direction of the vehicle directed toward the front of the vehicle, the left-hand side in the width direction of the vehicle directed toward the front of the vehicle, and the top of the vehicle, respectively. The “Fr”, “Rr”, “RH”, “LH”, and “Upr” are shown in the form of arrows in the drawings.

As illustrated in FIG. 1, a pair of support members 20 is disposed in the vehicle, and the support members 20 are placed on a floor panel 10 and extend in the width direction of the vehicle (up-down direction in FIG. 1). The floor panel 10 and the support members 20 are metallic component members constituting the body of the vehicle. The support members 20 are disposed apart from and in parallel to each other in the front-rear direction of the vehicle. The support member 20 that is disposed in the front of the vehicle (left in FIG. 1) and the support member 20 that is disposed in the rear of the vehicle (right in FIG. 1) are identical in configuration to each other. Accordingly, the configuration of the support member 20 that is disposed in the front of the vehicle will be described below and description of the support member 20 that is disposed in the rear of the vehicle will be omitted with the same reference numerals used to refer to parts common to the support members 20.

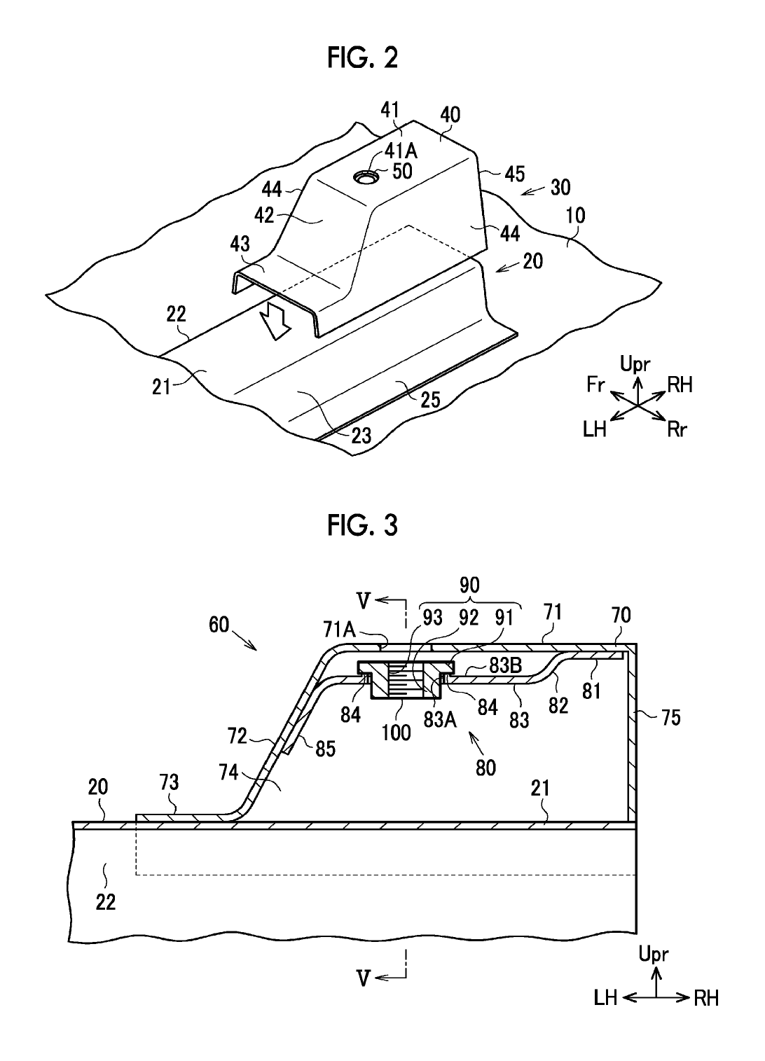

As illustrated in FIG. 2, the support member 20 has an abutment wall 21 that faces the floor panel 10. The abutment wall 21 is formed in an elongated plate shape and extends in the width direction of the vehicle. A front wall 22 and a rear wall 23 that extend downward are connected to both end portions of the abutment wall 21 in the front-rear direction of the vehicle. A first flange 24 extending to the front of the vehicle is connected to the lower end of the front wall 22. A second flange 25 extending to the rear of the vehicle is connected to the lower end of the rear wall 23. The first flange 24 and the second flange 25 abut against the upper surface of the floor panel 10. As indicated by circles in FIG. 1, the first flange 24 and the second flange 25 are joined to the floor panel 10 in a plurality of places in the width direction of the vehicle by, for example, welding. The abutment wall 21, the front wall 22, and the rear wall 23 of the support member 20 and the floor panel 10 constitute a closed section.

In the support member 20 that is disposed in the front of the vehicle, a connecting member 30 is connected to each end portion of the support member 20 in the width direction of the vehicle as illustrated in FIG. 1. The connecting member 30 is a metallic member. The connecting member 30 that is disposed on the right-hand side in the width direction of the vehicle (upper side in FIG. 1) and the connecting member 30 that is disposed on the left-hand side in the width direction of the vehicle (lower side in FIG. 1) are configured to be bilaterally symmetrical to each other. The configuration of the connecting member 30 that is disposed on the right-hand side in the width direction of the vehicle will be described below and description of the connecting member 30 that is disposed on the left-hand side in the width direction of the vehicle will be omitted with the same reference numerals used to refer to parts common to the connecting members 30.

As indicated by an arrow in FIG. 2, the connecting member 30 has a case 40 that is assembled with the support member 20 from above. The case 40 has an upper wall 41 that faces the abutment wall 21 of the support member 20. The upper wall 41 has a quadrangular plate shape and has a bolt insertion hole 41A. A curved wall 42 is connected to the left end portion of the upper wall 41. The curved wall 42 extends to the left-hand side in the width direction of the vehicle from the upper wall 41. The curved wall 42 is curved such that its end portion on the left-hand side has a lower position. A lower wall 43 is connected to the lower end of the curved wall 42, and the lower wall 43 extends to the left-hand side in the width direction of the vehicle from the curved wall 42. Both end portions of the upper wall 41, the curved wall 42, and the lower wall 43 in the front-rear direction of the vehicle are connected to one another by a pair of facing walls 44. The lower end portions of the facing walls 44 extend below the lower wall 43.

The case 40 also has a side wall 45 that connects the end portion of the upper wall 41 that is on the right-hand side in the width direction of the vehicle to the end portions of the facing walls 44 that are on the right-hand side in the width direction of the vehicle. The lower end portion of the side wall 45 has the same position as the lower wall 43 in the up-down direction of the vehicle. In other words, the lower end portions of the facing walls 44 extend below the side wall 45. In a state where the case 40 is placed by being assembled with the support member 20 from above, the side wall 45 and the lower wall 43 abut against the abutment wall 21 of the support member 20. In addition, the facing walls 44 extend below the abutment wall 21 and the lower end portions of the facing walls 44 cover the outside of the front wall 22 of the support member 20 and the outside of the rear wall 23 of the support member 20. One of the facing walls 44 abuts against the front wall 22 and the other one of the facing walls 44 abuts against the rear wall 23. The facing walls 44 are joined to the front wall 22 and the rear wall 23 in a plurality of places in the width direction of the vehicle by, for example, welding.

The connecting member 30 also has a welding nut 50 accommodated in the case 40. The welding nut 50 is disposed in accordance with the bolt insertion hole 41A in the upper wall 41 and is welded to the lower surface of the upper wall 41. The screw hole that is formed in the welding nut 50 is disposed on the same axis as the bolt insertion hole 41A and communicates with the bolt insertion hole 41A. The bolt insertion hole 41A is larger in diameter than the screw hole.

In the support member 20 that is disposed in the rear of the vehicle, a case-nut 60 is assembled with each end portion of the support member 20 in the width direction of the vehicle as illustrated in FIG. 1. The case-nut 60 that is disposed on the right-hand side in the width direction of the vehicle (upper side in FIG. 1) and the case-nut 60 that is disposed on the left-hand side in the width direction of the vehicle (lower side in FIG. 1) are configured to be bilaterally symmetrical to each other. The configuration of the case-nut 60 that is disposed on the right-hand side in the width direction of the vehicle will be described below and description of the case-nut 60 that is disposed on the left-hand side in the width direction of the vehicle will be omitted with the same reference numerals used to refer to parts common to the case-nuts 60.

As illustrated in FIG. 3, the case-nut 60 is provided with a case 70. The case 70 has the same configuration as the case 40 of the connecting member 30 described above. In other words, the case 70 is a metallic case and has a quadrangular plate-shaped upper wall 71 in which a bolt insertion hole 71A is formed. A curved wall 72 is connected to the end portion of the upper wall 71 that is on the left-hand side in the width direction of the vehicle (left end portion in FIG. 3). The curved wall 72 extends to the left-hand side in the width direction of the vehicle from the upper wall 71. The curved wall 72 is curved such that its end portion on the left-hand side has a lower position. A lower wall 73 is connected to the lower end of the curved wall 72, and the lower wall 73 extends to the left-hand side in the width direction of the vehicle from the curved wall 72. Both end portions of the upper wall 71, the curved wall 72, and the lower wall 73 in the front-rear direction of the vehicle are connected to one another by a pair of facing walls 74. The lower end portions of the facing walls 74 extend below the lower wall 73. The case 70 also has a side wall 75 that connects the end portion of the upper wall 71 that is on the right-hand side in the width direction of the vehicle to the end portions of the facing walls 74 that are on the right-hand side in the width direction of the vehicle (right end portions in FIG. 3). The side wall 75 and the lower wall 73 abut against the abutment wall 21 of the support member 20. The curved wall 72, the lower wall 73, the facing walls 74, and the side wall 75 constitute peripheral walls established downward from the peripheral edges of the upper wall 71 of the case 70. The facing walls 74 extend below the abutment wall 21 and the lower end portions of the facing walls 74 cover the outside of the front wall 22 of the support member 20 and the outside of the rear wall 23 of the support member 20. One of the facing walls 74 abuts against the front wall 22 and the other one of the facing walls 74 abuts against the rear wall 23. The facing walls 74 are joined to the front wall 22 and the rear wall 23 in a plurality of places in the width direction of the vehicle by, for example, welding. In other words, the tip portions of the peripheral walls in the direction in which the peripheral walls are established (lower end portions in FIG. 3) are welded to the body. A metallic support bracket 80 is accommodated in the case 70.

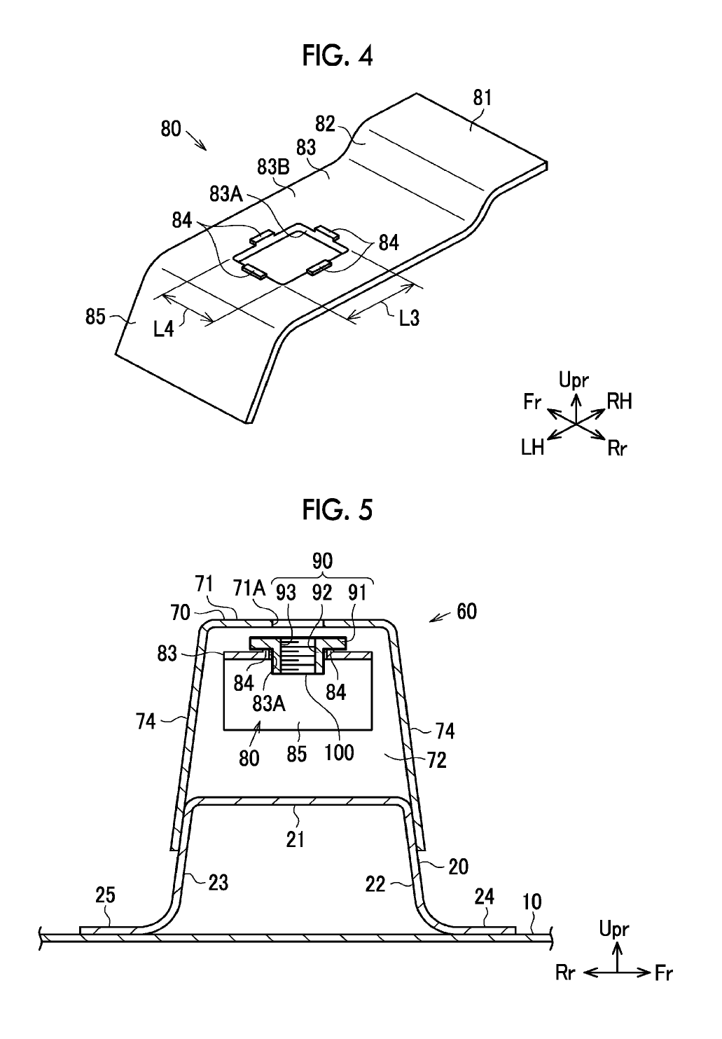

As illustrated in FIGS. 3 and 4, the support bracket 80 is formed in a curved plate shape and extends in the width direction of the vehicle. The support bracket 80 has a first connecting portion 81 abutting against the upper wall 71 of the case 70. The first connecting portion 81 extends in parallel to the upper wall 71. An inclined extending portion 82 is connected to the end portion of the first connecting portion 81 that is on the left-hand side in the width direction of the vehicle (left end portion in FIG. 3). The inclined extending portion 82 extends to the left-hand side in the width direction of the vehicle from the first connecting portion 81. The inclined extending portion 82 is inclined such that its left-hand side in the width direction of the vehicle (left side in FIG. 3) has a lower position. A support portion 83 is connected to the lower end of the inclined extending portion 82. The support portion 83 extends in parallel to the upper wall 71 and is separated from the upper wall 71. As illustrated in FIG. 4, a through-hole 83A is formed in the support portion 83. The through-hole 83A is formed in a rectangular shape, has the width direction of the vehicle as its longitudinal direction (length L3), and has the front-rear direction of the vehicle as its short direction (length L4). A plurality of projecting portions 84 established along the peripheral edges of the through-hole 83A is formed on a support surface 83B of the support portion 83 that faces the upper wall 71. The projecting portions 84 have the same rectangular parallelepiped shape. A second connecting portion 85 is connected to the end portion of the support portion 83 that is on the left-hand side in the width direction of the vehicle (left end portion in FIG. 3). The second connecting portion 85 extends at an angle along the curved wall 72 of the case 70 such that its left-hand side in the width direction of the vehicle (left side in FIG. 3) has a lower position. The second connecting portion 85 abuts against the curved wall 72. The support bracket 80 is connected to the case 70 in a state where the support bracket 80 is separated from the body of the vehicle by the first connecting portion 81 and the upper wall 71 being joined to each other and the second connecting portion 85 and the curved wall 72 being joined to each other by welding or the like.

As illustrated in FIG. 5, the length of the support bracket 80 in the front-rear direction of the vehicle (right-left direction in FIG. 5) is shorter than the length between the facing walls 74 of the case 70. Accordingly, the support bracket 80 is separated from the facing walls 74 in a state where the support bracket 80 is connected as described above.

The case-nut 60 also has a metallic nut 90. As illustrated in FIGS. 3 and 5, the nut 90 has a flange portion 91 and a main body portion 92. The flange portion 91 is disposed between the upper wall 71 of the case 70 and the support portion 83 of the support bracket 80. The main body portion 92 is connected to the middle portion of the flange portion 91 and extends into the through-hole 83A.

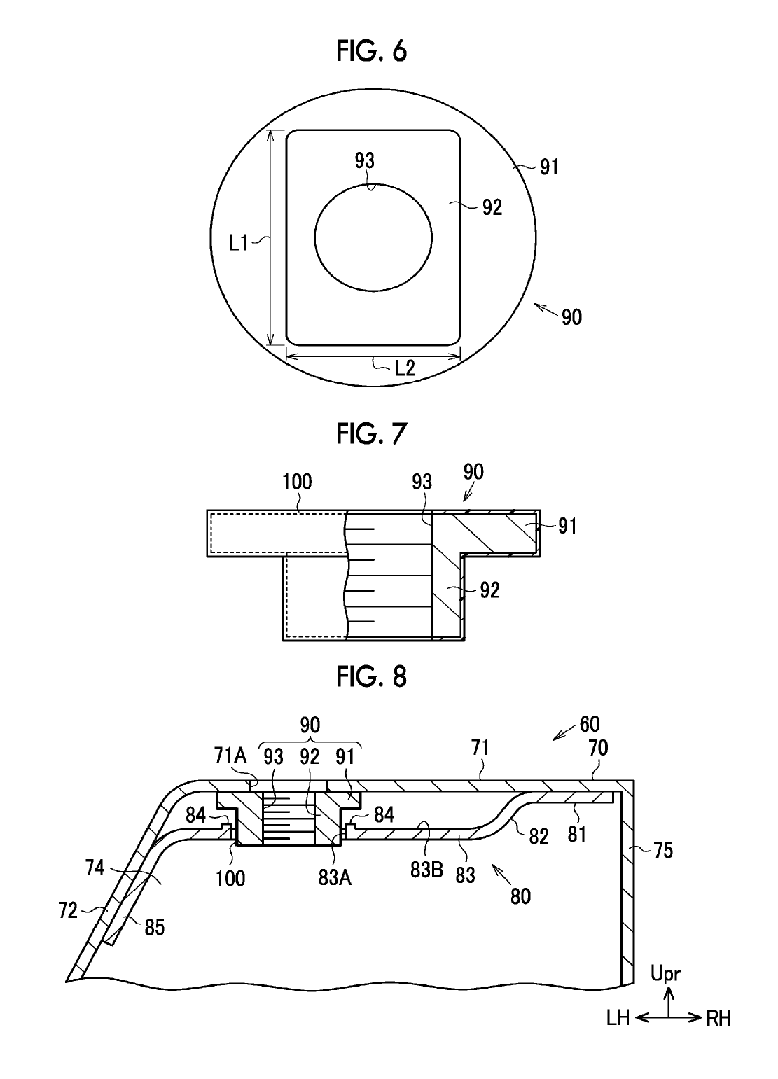

As illustrated in FIG. 6, the flange portion 91 is formed in a disc shape. The main body portion 92 is formed in a rectangular parallelepiped shape and has a rectangular bottom surface. A length L1 of the bottom surface of the main body portion 92 in the longitudinal direction is shorter than the length L3 of the through-hole 83A in the longitudinal direction and is longer than the length L4 of the through-hole 83A in the short direction (L3>L1>L4). A length L2 of the bottom surface of the main body portion 92 in the short direction is shorter than the length L4 of the through-hole 83A in the short direction (L4>L2). A screw hole 93 is formed in the nut 90, and the screw hole 93 extends through the flange portion 91 and the main body portion 92. The screw hole 93 is formed in the middle of the flange portion 91 and the middle of the main body portion 92.

As illustrated in FIGS. 3 and 5, the main body portion 92 is inserted into the through-hole 83A in the support bracket 80 such that the longitudinal direction of the main body portion 92 is the same as the longitudinal direction of the through-hole 83A, that is, such that the short direction of the main body portion 92 is the same as the short direction of the through-hole 83A. The shape of the main body portion 92 and the shape of the through-hole 83A are formed based on the above-described length relationship, and thus a gap is formed in the width direction of the vehicle (right-left direction in FIG. 3) between the main body portion 92 of the nut 90 and the support bracket 80 as illustrated in FIG. 3. In addition, a gap is formed in the front-rear direction of the vehicle (right-left direction in FIG. 5) between the main body portion 92 of the nut 90 and the support bracket 80 as illustrated in FIG. 5. Accordingly, the main body portion 92 is capable of moving in the width direction of the vehicle and the front-rear direction of the vehicle in the through-hole 83A.

The outer diameter of the flange portion 91 is larger than the outer diameter of the bolt insertion hole 71A formed in the upper wall 71 of the case 70 and is larger than the outer diameter of the through-hole 83A in the support bracket 80. In other words, in a state where the flange portion 91 is disposed between the upper wall 71 of the case 70 and the support portion 83 of the support bracket 80 as illustrated in FIGS. 3 and 5, upward disengagement of the nut 90 through the bolt insertion hole 71A and dropping of the nut 90 through the through-hole 83A are more appropriately suppressed. The length of the nut 90 in the up-down direction is longer than the distance between the upper wall 71 of the case 70 and the support portion 83 of the support bracket 80. Accordingly, a movement of the nut 90 as a whole into the space between the upper wall 71 of the case 70 and the support portion 83 of the support bracket 80 is more appropriately suppressed as well. The nut 90 is supported by the support bracket 80 in the case 70 and is disposed apart from the support member 20.

An insulating film 100 that covers the entire outer surface of the nut 90 is laminated on the nut 90 as illustrated in FIG. 7. An insulating resin such as epoxy resin constitutes the insulating film 100. The thickness of the insulating film 100 is set to 5 micrometers to 40 micrometers. More preferably, the thickness of the insulating film 100 is set to 10 micrometers to 30 micrometers. Even more preferably, the thickness of the insulating film 100 is set to 15 micrometers to 20 micrometers. In the present embodiment, the insulating film 100 is laminated on the entire outer surface of the nut 90 by cation electrodeposition coating. During the cation electrodeposition coating, the nut 90 is dipped into a tub filled with water-soluble resin paint, and then a direct current is allowed to flow with the inside of the tub being anodic and the nut 90 being cathodic. Then, the resin around the nut 90 is precipitated and a coating film is produced. Subsequently, the nut 90 is taken out of the tub and dried at a high temperature. In the present embodiment, the insulating film 100 with a thickness of 15 micrometers is laminated on the entire outer surface of the nut 90 as a result of the electrodeposition coating described above.

In a state where the nut 90 is accommodated in the case 70, the insulating film 100 that is laminated on the lower surface side of the flange portion 91 of the nut 90 abuts against the upper surfaces of the projecting portions 84 of the support bracket 80 as illustrated in FIGS. 3 and 5.

In the present embodiment, the connecting member 30 and the case-nut 60 are welded to the support member 20 after the support member 20 is welded to the floor panel 10. At this time, the case-nut 60 is in a state where the nut 90 is accommodated in the case 70 with the entire outer surface of the nut 90 coated with the insulating film 100. Subsequently, the electrodeposition coating is performed with the floor panel 10, the support member 20, the connecting member 30, and the case-nut 60 integrated with one another. The electrodeposition coating is to ensure corrosion resistance of the vehicle, and conductive electrodeposition paint is used for the electrodeposition coating.

After the electrodeposition coating is performed as described above, a pair of guide rails 200 extending in the front-rear direction of the vehicle is assembled with the connecting members 30 and the case-nuts 60 as indicated by the two-dot chain lines in FIG. 1. The guide rails 200 are members constituting the slide rail of the vehicle seat and are disposed apart from each other in the width direction of the vehicle. The guide rail 200 has a bottom wall 201 and a pair of sliding walls 202. The bottom wall 201 has an elongated plate shape and extends in the front-rear direction of the vehicle. The sliding walls 202 extend upward and are connected to both end portions of the bottom wall 201 in the width direction of the vehicle. Bolt fastening holes (not illustrated) separated from each other in the front-rear direction of the vehicle are formed in the bottom wall 201. When the guide rail 200 is assembled, the guide rail 200 is placed such that the connecting member 30 and the case-nut 60 are connected, and then the bolt fastening hole that is disposed in the front of the vehicle is aligned with the position of the bolt insertion hole 41A formed in the upper wall 41 of the connecting member 30. Then, a bolt is inserted from the top of the vehicle into the bolt fastening hole and the bolt insertion hole 41A, and the bolt is fastened to the welding nut 50 welded to the upper wall 41 of the connecting member 30. Subsequently, a bolt is inserted from the top of the vehicle into the bolt fastening hole that is disposed in the rear of the vehicle and the bolt insertion hole 71A formed in the upper wall 71 of the case-nut 60.

The distance between the bolt fastening holes in the guide rail 200 and the distance between the bolt insertion hole 41A in the connecting member 30 and the bolt insertion hole 71A in the case-nut 60 may be slightly different from vehicle to vehicle depending on, for example, the manufacturing tolerance of the guide rail 200, the assembly tolerance of the connecting member 30 with respect to the support member 20, and the assembly tolerance of the case-nut 60 with respect to the support member 20. In the case-nut 60, the bolt insertion hole 71A is larger in diameter than the shaft portion of the bolt and the nut 90 is disposed such that it can be moved with respect to the case 70 and the support bracket 80. Accordingly, the bolt can be fastened with the axes of the nut 90 and the bolt aligned with each other even when the insertion position of the bolt with respect to the bolt insertion hole 71A changes. The nut 90 abuts against the upper wall 71 of the case 70 by the bolt and the nut 90 being fastened to each other. The guide rail 200 is appropriately assembled with the support member 20 via the connecting member 30 and the case-nut 60 as the misalignment of the assembly position of the guide rail 200 that is attributable to the above-described tolerances is absorbed by the nut 90 in the case-nut 60 being moved as described above. A moving rail (not illustrated) connected to a lower portion of the vehicle seat is assembled with the guide rail 200. The moving rail is a component member of the slide rail. The vehicle seat can be slid by the moving rail sliding with respect to the guide rail 200.

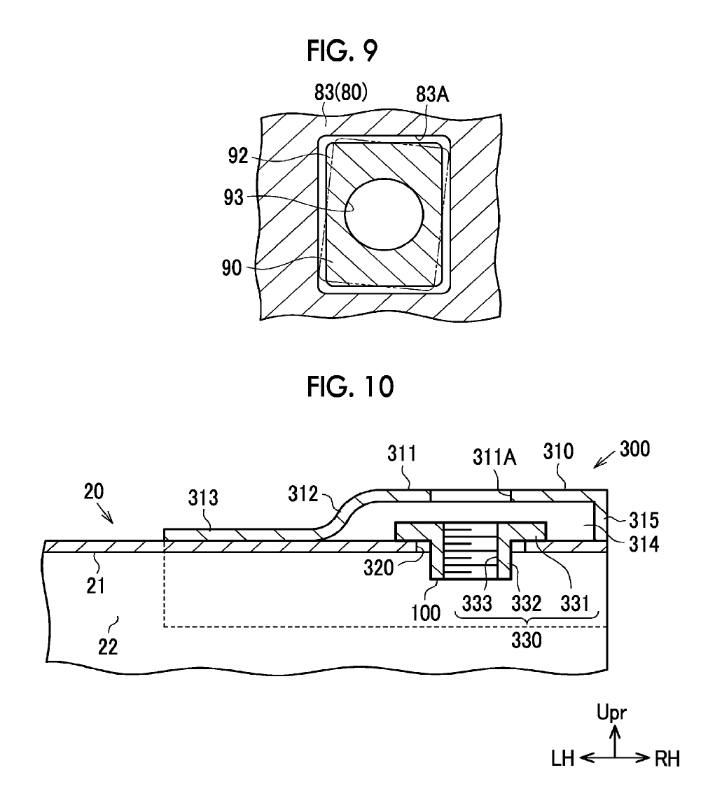

The action and effect of the present embodiment will be described below with reference to FIGS. 8 and 9.

(1) The case-nut 60 is assembled with the body by the case 70 being welded to the support member 20 in a state where the nut 90 is accommodated in the case 70. In some cases, the nut 90 is magnetized by, for example, the magnetic field that is generated when the case 70 is welded to the support member 20.

Once the nut 90 is magnetized, the nut 90 may be drawn and attached to the upper wall 71 of the case 70, as illustrated in FIG. 8, by the magnetic force that results from the magnetization. In the present embodiment, the insulating film 100 is disposed on the end face of the nut 90 on the case 70 side, that is, the upper surface of the flange portion 91 of the nut 90. Accordingly, in a state where the nut 90 is attached to the upper wall 71 of the case 70, the nut 90 is connected to the case 70 via the insulating film 100 that is disposed on the upper surface of the flange portion 91. As a result, insulation of the nut 90 is ensured with respect to the case 70.

In a case where the nut 90 is not magnetized, for example, the position of the nut 90 is lowered by gravity. In this case, the nut 90 may be separated from the upper wall 71 of the case 70 and placed on the support bracket 80 as illustrated in FIG. 3. The support bracket 80 is disposed on the body side of the nut 90. The support bracket 80 is connected to the case 70 joined to the support member 20 and is conductible with respect to the body. In the present embodiment, the insulating film 100 is disposed on the side surface of the main body portion 92 and the lower surface of the flange portion 91, which is the end face of the nut 90 on the body side, as well. Accordingly, in a state where the nut 90 is placed, the insulating film 100 that is laminated on the side surface of the main body portion 92 and the lower surface of the flange portion 91, which is the end face of the nut 90 on the body side, abuts against the support bracket 80. As a result, insulation of the nut 90 is ensured with respect to the body as well.

The nut 90 can be moved in the through-hole 83A in a state where the nut 90 is attached to the upper wall 71 and in a state where the nut 90 is placed on the support bracket 80. In the present embodiment, the insulating film 100 is disposed on the side surface of the main body portion 92 that is inserted into the through-hole 83A. Accordingly, the side surface of the main body portion 92 is not in contact with the support bracket 80 and insulation of the nut 90 is ensured with respect to the body.

Accordingly, energization of the nut 90 via the case 70, the support bracket 80, and the body is more appropriately suppressed when electrodeposition coating is performed on the body that is assembled with the case-nut 60. Therefore, no coating film is produced on the outer surface of the nut 90 during electrodeposition coating, and sticking of the nut 90 to the case 70, the support bracket 80, and the body attributable to a coating film can be more appropriately suppressed.

(2) The thickness of the insulating film 100 is set to 15 micrometers. Once the bolt is fastened to the nut 90 in the case-nut 60, the upper surface of the flange portion 91 of the nut 90 is pressed against the case 70 and the insulating film 100 is sandwiched by the nut 90 and the case 70. In the present embodiment, the insulating film 100 has a relatively small thickness, and thus the insulating film 100 rarely affects the fastening and the same fastening force as in a case where the insulating film 100 is not disposed can be guaranteed. In addition, the insulating film 100 is unlikely to peel off even when it cracks, and peeling of the insulating film 100 can be hindered. Accordingly, abnormal noise generation attributable to peeling of the insulating film 100 in the case-nut 60 can be more appropriately suppressed.

(3) The insulating film 100 covers the entire outer surface of the nut 90, and thus the nut 90 is reliably insulated with respect to the case 70 and the support bracket 80. Accordingly, sticking of the nut 90 to the case 70 and the support bracket 80 attributable to electrodeposition coating can be more appropriately suppressed.

(4) As illustrated in FIG. 9, the length L1 of the bottom surface of the main body portion 92 of the nut 90 in the longitudinal direction (up-down direction in FIG. 9) is shorter than the length L3 of the through-hole 83A in the longitudinal direction and is longer than the length L4 of the through-hole 83A in the short direction. The length L2 of the bottom surface of the main body portion 92 in the short direction (right-left direction in FIG. 9) is shorter than the length L4 of the through-hole 83A in the short direction. Accordingly, when the main body portion 92 of the nut 90 rotates, the side surface of the main body portion 92 is locked to the inner peripheral surface of the support bracket 80 and the rotation of the main body portion 92 is limited by the support bracket 80 as indicated by the two-dot chain line in FIG. 9. Therefore, rotation of the nut 90 is regulated when the bolt inserted into the bolt insertion hole 71A in the case-nut 60 is fastened to the nut 90, and fastening workability can be improved.

(5) According to the above configuration, the projecting portions 84 are formed on the support portion 83 of the support bracket 80 and the flange portion 91 of the nut 90 is placed on the projecting portions 84. Accordingly, a gap is formed between the flange portion 91 of the nut 90 and the support portion 83 of the support bracket 80. As a result, paint is discharged from the case-nut 60 through the space between the nut 90 and the support bracket 80 when electrodeposition coating is performed with the floor panel 10, the support member 20, the connecting member 30, and the case-nut 60 integrated with one another. Therefore, sticking between the nut 90 and the support bracket 80 can be more appropriately suppressed.

The above-described embodiment can also be implemented in modified forms as follows. The shape and number of the projecting portions 84 can be changed. In addition, the projecting portions 84 may have different shapes. Furthermore, the projecting portions 84 may be disposed on the lower surface of the flange portion 91 of the nut 90 without being disposed on the support portion 83 of the support bracket 80. When this configuration is adopted, a gap is still formed between the flange portion 91 of the nut 90 and the support portion 83 of the support bracket 80. The projecting portions 84 may be omitted, too.

The main body portion 92 does not necessarily have to be connected to the middle portion of the flange portion 91. The bottom surface of the main body portion 92 and the through-hole 83A may have a non-rectangular shape as well. For example, the shape of the bottom surface of the main body portion 92 can be polygonal or elliptical instead of being rectangular. Even in this case, rotation of the main body portion 92 can be stopped, by the shape of the through-hole 83A being set such that the side surface of the main body portion 92 is locked to the inner peripheral surface of the support bracket 80, when the main body portion 92 rotates. In an alternative configuration, rotation of the main body portion 92 may be stopped by a part other than the inner peripheral surface that constitutes the through-hole 83A of the support bracket 80 being locked to the side surface of the main body portion 92.

The detent structure for the main body portion 92 can be omitted, too. In this case, a configuration in which the bottom surface of the main body portion 92 has a circular shape and the through-hole 83A has a circular shape can be adopted as an example.

The support bracket 80 may be omitted as well. In this case, a configuration illustrated in FIG. 10 can be adopted as an example. As illustrated in FIG. 10, a case-nut 300 is provided with a case 310. The case 310 is a metallic case and has a quadrangular plate-shaped upper wall 311 in which a bolt insertion hole 311A is formed. A curved wall 312 is connected to the end portion of the upper wall 311 that is on the left-hand side in the width direction of the vehicle (left end portion in FIG. 10). The curved wall 312 extends to the left-hand side in the width direction of the vehicle from the upper wall 311. The curved wall 312 is curved such that its end portion on the left-hand side has a lower position. A lower wall 313 is connected to the lower end of the curved wall 312, and the lower wall 313 extends to the left-hand side in the width direction of the vehicle from the curved wall 312. Both end portions of the upper wall 311, the curved wall 312, and the lower wall 313 in the front-rear direction of the vehicle (depth direction in FIG. 10) are connected to one another by a pair of facing walls 314. The lower end portions of the facing walls 314 extend below the lower wall 313.

The case 310 also has a side wall 315 that connects the end portion of the upper wall 311 that is on the right-hand side in the width direction of the vehicle to the end portions of the facing walls 314 that are on the right-hand side in the width direction of the vehicle (right end portions in FIG. 10). The side wall 315 and the lower wall 313 abut against the abutment wall 21 of the support member 20. The facing walls 314 extend below the abutment wall 21 and the lower end portions of the facing walls 314 cover the outside of the front wall 22 of the support member 20 and the outside of the rear wall 23 of the support member 20. One of the facing walls 314 abuts against the front wall 22 and the other one of the facing walls 314 abuts against the rear wall 23. The facing walls 314 are joined to the front wall 22 and the rear wall 23 in a plurality of places in the width direction of the vehicle by, for example, welding. As a result, the case 310 is welded to the body.

A rectangular communication hole 320 is formed in the abutment wall 21 of the support member 20. The communication hole 320 allows the inner region of the support member 20 and the inner region of the case 310 to communicate with each other. The case-nut 300 also has a metallic nut 330. The nut 330 has a flange portion 331 and a main body portion 332. The flange portion 331 is disposed between the upper wall 311 of the case 310 and the abutment wall 21 of the support member 20. The main body portion 332 is connected to the middle portion of the flange portion 331 and extends into the communication hole 320. The flange portion 331 is formed in a disc shape. The main body portion 332 is formed in a rectangular parallelepiped shape. A predetermined gap is formed in the front-rear direction of the vehicle and the width direction of the vehicle between the side surface of the main body portion 332 and the inner peripheral surface that constitutes the communication hole 320 in the abutment wall 21. Accordingly, the main body portion 332 can be moved in the width direction of the vehicle and the front-rear direction of the vehicle in the communication hole 320. A screw hole 333 is formed in the nut 330, and the screw hole 333 extends through the flange portion 331 and the main body portion 332. The screw hole 333 is formed in the middle of the flange portion 331 and the middle of the main body portion 332.

The outer diameter of the flange portion 331 is set to a length that allows upward disengagement of the nut 330 through the bolt insertion hole 311A and dropping of the nut 330 through the communication hole 320 to be more appropriately suppressed. The length of the nut 330 in the up-down direction is longer than the distance between the upper wall 311 of the case 310 and the abutment wall 21 of the support member 20. Accordingly, a movement of the nut 330 as a whole into the space between the upper wall 311 of the case 310 and the abutment wall 21 of the support member 20 is more appropriately suppressed as well. The insulating film 100 that covers the entire outer surface of the nut 330 is laminated on the nut 330. In a state where the nut 330 is accommodated in the case 310, the insulating film 100 that is laminated on the lower surface of the flange portion 331 of the nut 330 abuts against the upper surface of the abutment wall 21.

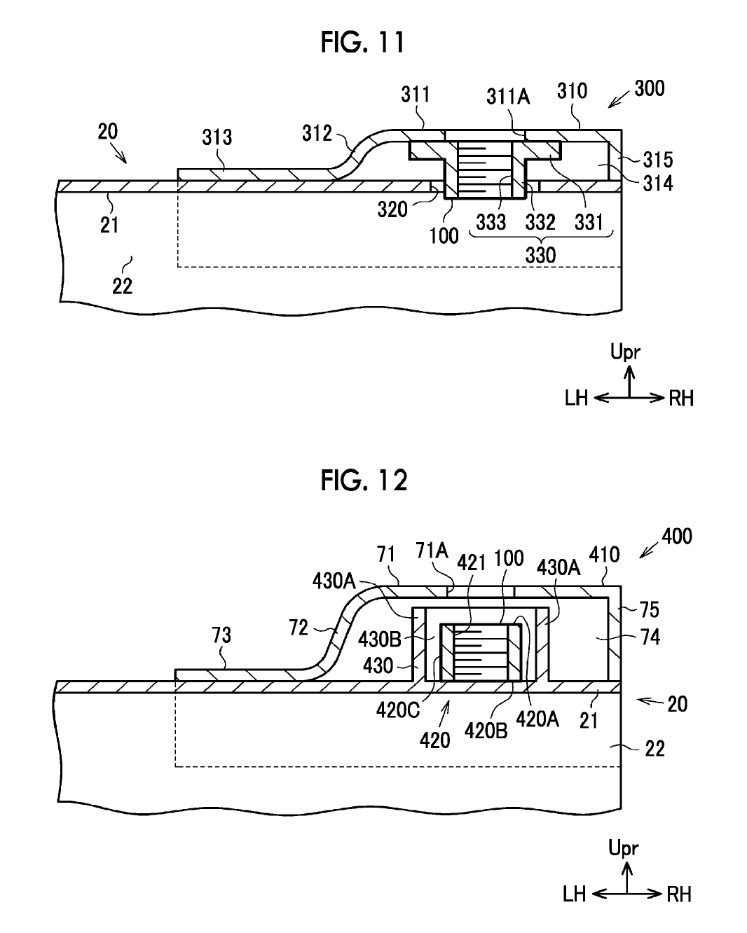

In the configuration described above, the nut 330 is connected to the case 310 via the insulating film 100 that is disposed on the end face of the nut 330 on the case 310 side, that is, the upper surface of the flange portion 331 of the nut 330, as illustrated in FIG. 11, in a case where the nut 330 is magnetized and attached to the upper wall 311. As a result, insulation of the nut 330 is ensured with respect to the case 310.

In a state where the position of the nut 330 is lowered and the nut 330 is separated from the upper wall 311 of the case 310 and placed on the support member 20 as illustrated in FIG. 10, the insulating film 100 that is laminated on the side surface of the main body portion 332 and the lower surface of the flange portion 331, which is the end face of the nut 330 on the support member 20 side, abuts against the support member 20. Accordingly, insulation of the nut 330 can be ensured with respect to the body.

The insulating film 100 is also disposed on the side surface of the main body portion 332 that constitutes the end face of the nut 330 on the body side. Accordingly, the main body portion 332 is not in contact with the support bracket 80 and insulation of the nut 330 is ensured with respect to the body even when the nut 330 moves in a state where the nut 330 is attached to the upper wall 311. Accordingly, the same action and effect as in (1) can be achieved.

According to the above configuration, the entire outer surfaces of the nuts 90, 330 are covered by the insulating film 100. In addition to this configuration, at least a part of the inner surfaces of the nuts 90, 330 may be covered by the insulating film 100. In other words, at least a part of the screw holes 93, 333 in the nuts 90, 330 may be covered by the insulating film 100.

The outer surfaces of the nuts 90, 330 may be partially covered by the insulating film 100 as well. In other words, the insulating film 100 may be disposed on the end faces of the nuts 90, 330 on the cases 70, 310 side and the end faces of the nuts 90, 330 on the body side with the insulating film 100 not disposed on the end faces that are unlikely to abut against the cases 70, 310 and the body, examples of which include the side surfaces of the flange portions 91, 331 and the bottom surfaces of the main body portions 92, 332.

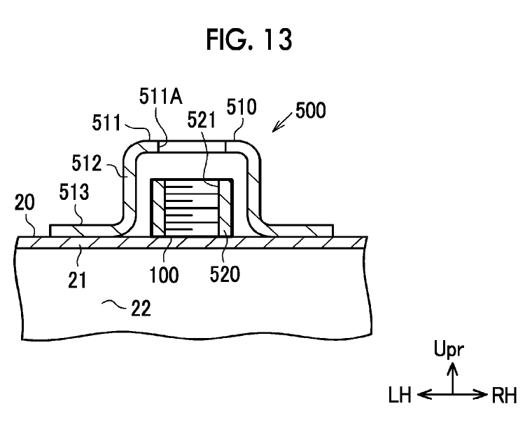

The configuration of the nuts 90, 330 is not limited to the configuration described above. For example, a configuration illustrated in FIGS. 12 and 13 may also be adopted. As illustrated in FIG. 12, a case-nut 400 is provided with a case 410. The case 410 is similar in configuration to the case 70 described above, and thus detailed description thereof will be omitted with the same reference numerals used to refer to parts common to the case 410 and the case 70. A nut 420 is accommodated in the case 410. The nut 420 is formed in a rectangular parallelepiped shape. A screw hole 421 is formed at the center of the nut 420. A support wall 430 is disposed in the support member 20, and the support wall 430 is connected to the upper surface of the abutment wall 21 and is established on the upper wall 71 side of the case 410. A pair of longitudinal side walls 430A and a pair of short side walls 430B constitute the support wall 430. The longitudinal side walls 430A face each other in the width direction of the vehicle (right-left direction in FIG. 12). The short side walls 430B connect both ends of the longitudinal side walls 430A in the front-rear direction of the vehicle to each other. The length of the longitudinal side wall 430A is longer than the length of the short side wall 430B. In other words, the support wall 430 has a rectangular frame shape, has the front-rear direction of the vehicle (depth direction in FIG. 12), which is the drawing direction of the longitudinal side wall 430A, as its longitudinal direction, and has the width direction of the vehicle, which is the drawing direction of the short side wall 430B, as its short direction.

The nut 420 is disposed in the inner region of the support wall 430 such that the longitudinal direction of the bottom surface of the nut 420 is the same as the longitudinal direction of the support wall 430. The side surface of the nut 420 is separated from the inner peripheral surface of the support wall 430. Accordingly, the nut 420 can be moved in the width direction of the vehicle and the front-rear direction of the vehicle in the inner region of the support wall 430. The length of the longitudinal side wall 430A of the support wall 430 and the length of the short side wall 430B of the support wall 430 are set such that the side surface of the nut 420 is locked to the inner peripheral surface of the support wall 430 when the nut 420 rotates. In other words, the support wall 430 has a function as a detent for the nut 420. The bottom surface of the nut 420 is wider than the bolt insertion hole 71A in the case 410. Accordingly, upward disengagement of the nut 420 through the bolt insertion hole 71A is more appropriately suppressed.

The insulating film 100 that covers the entire outer surface of the nut 420, that is, an upper surface 420A, a bottom surface 420B, and a side surface 420C of the nut 420 is laminated on the nut 420. In a state where the position of the nut 420 is lowered and the nut 420 is separated from the upper wall 71 of the case 410 and placed on the abutment wall 21 of the support member 20, the insulating film 100 that is disposed on the bottom surface 420B and the side surface 420C, which are the end faces of the nut 420 that are on the body side, abuts against the body. In other words, the insulating film 100 that is laminated on the bottom surface 420B of the nut 420 abuts against the abutment wall 21 and the insulating film 100 that is laminated on the side surface 420C of the nut 420 abuts against the support wall 430. Accordingly, insulation of the nut 420 can be ensured with respect to the body.

In the configuration described above, the nut 420 is connected to the case 410 via the insulating film 100 that is disposed on the end face of the nut 420 on the case 410 side, that is, the upper surface 420A of the nut 420 in a case where the nut 420 is magnetized and attached to the upper wall 71. As a result, insulation of the nut 420 is ensured with respect to the case 410. The insulating film 100 is laminated on the side surface 420C that constitutes the end face of the nut 420 on the body side, and thus the side surface of the nut 420 is not in contact with the support wall 430 and insulation of the nut 420 is ensured with respect to the body even when the nut 420 moves in a state where the nut 420 is attached to the upper wall 71.

Accordingly, this configuration also allows insulation of the nut 420 to be ensured with respect to the case 410 and the body in a state where the nut 420 is accommodated in the case 410.

As illustrated in FIG. 13, a case-nut 500 is provided with a case 510. The case 510 is a metallic case. The case 510 has a disc-shaped upper wall 511 in which a bolt insertion hole 511A is formed. A cylindrical side wall 512 is connected to the peripheral edge of the upper wall 511. A flange 513 extending radially outward is connected to the lower end of the side wall 512. The flange 513 abuts against the abutment wall 21 of the support member 20. The case 510 is assembled with the support member 20 by the flange 513 and the abutment wall 21 being, for example, welded to each other.

The case-nut 500 also has a metallic nut 520. The nut 520 is formed in a columnar shape. A screw hole 521 is formed at the center of the nut 520. The outer diameter of the nut 520 is larger than the outer diameter of the bolt insertion hole 511A and is smaller than the inner diameter of the side wall 512. The insulating film 100 that covers the entire outer surface of the nut 520 is laminated on the nut 520. In a state where the position of the nut 520 is lowered and the nut 520 is separated from the upper wall 511 of the case 510 and placed on the abutment wall 21 of the support member 20, the insulating film 100 that is disposed on the bottom surface of the nut 520, which is the end face of the nut 520 that is on the body side, abuts against the abutment wall 21. Accordingly, insulation of the nut 520 can be ensured with respect to the body.

The nut 520 is connected to the case 510 via the insulating film 100 that is disposed on the end face of the nut 520 on the case 510 side, that is, the upper surface of the nut 520 in a case where the nut 520 is magnetized and attached to the upper wall 511. As a result, insulation of the nut 520 is ensured with respect to the case 510. The insulating film 100 is also laminated on the side peripheral surface that constitutes the end face of the nut 520 on the case 510 side, and thus the side peripheral surface of the nut 520 is not in contact with the side wall 512 and insulation of the nut 520 is ensured with respect to the case 510 even when the nut 520 moves in a state where the nut 520 is attached to the upper wall 71.

Accordingly, this configuration also allows insulation of the nut 520 to be ensured with respect to the case 510 and the body. Although the thickness of the insulating film 100 is set to 15 micrometers in the configuration described above, the thickness of the insulating film 100 may be set within a range of 5 micrometers to 40 micrometers. In addition, the thickness of the insulating film 100 may be less than 5 micrometers or more than 40 micrometers.

A method for laminating the insulating film 100 on the nuts 90, 330, 420, 520 is not limited to cation electrodeposition coating. For example, anion electrodeposition coating may be used instead. In addition, the insulating film 100 may be laminated on the outer surfaces of the nuts 90, 330, 420, 520 by a method other than electrodeposition coating.

The electrodeposition paint that is used when electrodeposition coating is performed with the floor panel 10, the support member 20, the connecting member 30, and the case-nuts 60, 300, 400, 500 integrated with one another may have insulating properties.

In the example described above, the case-nuts 60, 300, 400, 500 are connected to the support member 20 that is disposed in the rear of the vehicle. However, the case-nuts 60, 300, 400, 500 may also be connected to the support member 20 disposed on the front of the vehicle instead of the connecting member 30.

In the example described above, the case-nuts 60, 300, 400, 500 are used for the slide rail of the vehicle seat to be fastened to the body of the vehicle. However, the disclosure is not limited thereto. In other words, a configuration that is similar to the configuration described above may be applied to a case-nut used for another member to be fastened to the body of the vehicle.

What is claimed is:

1. A case-nut comprising:
a case welded to a body of a vehicle, a bolt insertion hole being formed in the case;
a nut accommodated in the case and disposed to be movable in the case; and
an insulating film including at least a first insulating film laminated on an end face of the nut on a case side and a second insulating film laminated on an end face of the nut on a body side.

2. The case-nut according to claim 1, wherein the insulating film has a thickness of 5 micrometers to 40 micrometers.

3. The case-nut according to claim 1, wherein the insulating film covers an entire outer surface of the nut.

4. The case-nut according to claim 1, further comprising a support bracket accommodated in the case and including a connecting portion joined to the case and a support portion supporting the nut.

5. The case-nut according to claim 4, wherein the support portion of the support bracket has a through-hole into which the nut is inserted.

6. The case-nut according to claim 5, wherein the nut includes a flange portion disposed between an upper wall of the case and the support portion of the support bracket and a main body portion connected to the flange portion and extending into the through-hole of the support portion.

7. The case-nut according to claim 6, wherein the first insulating film is disposed on an upper surface of the flange portion, which is the end face of the nut on the case side.

8. The case-nut according to claim 6, wherein the second insulating film is disposed on a lower surface of the flange portion, which is the end face of the nut on the body side, the insulating film further includes a third insulating film laminated on a side surface of the main body portion, and the second insulating film and the third insulating film abut against the support bracket.
